(19) United States
(12) Patent Application Publication
(10) Pub. No.: US 2025/0392421 A1
(43) Pub. Date: Dec. 25, 2025

(54) REFERENCE SIGNALS FOR ACCESS POINT AND USER EQUIPMENT CONFIGURATION

(71) Applicant: Lenovo (Singapore) Pte. Ltd., Singapore (SG)

(72) Inventors: Khaled Nafez Rauf Ardah, Ilmenau (DE); Mahdi Barzegar Khalilsarai, Berlin (DE); Ahmed Hindy, Aurora, IL (US)

(73) Assignee: Lenovo (Singapore) Pte. Ltd., Singapore (SG)

(21) Appl. No.: 18/750,775

(22) Filed: Jun. 21, 2024

(51) Int. Cl. H04L 5/00; H04W 72/1268; H04W 72/23

(52) U.S. Cl. CPC H04L 5/0048; H04L 5/0073; H04W 72/1268; H04W 72/23

(57) ABSTRACT

Various aspects of the present disclosure relate to reference signals for access point and user equipment configuration. An apparatus, such as a user equipment (UE), receives, from one or more access points a first configuration message comprising one or more uplink transmit reference signal resources, one or more inter-UE cross-link interference measurement resources, and one or more inter-UE cross-link interference reporting resources. The apparatus transmits, based at least in part on the first configuration message, one or more uplink transmit reference signals comprising at least one of one or more inter-UE cross-link interference reference signals or one or more uplink channel state information reference signals. The apparatus receives, based at least in part on the first configuration message, at least one of one or more uplink transmit reference signals from one or more UEs or one more downlink reference signals from one or more access points.

### TECHNICAL FIELD

The present disclosure relates to wireless communications, and more specifically to multiple-input multiple-output (MIMO) networks.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or NE (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication to receive, from one or more access points (APs), a first configuration message including one or more uplink (UL) transmit reference signal (RS) resources, one or more inter-UE cross-link interference (CLI) measurement resources, and one or more inter-UE CLI reporting resources; transmit, based at least in part on the first configuration message, one or more UL transmit RSs including at least one of one or more inter-UE CLI RSs or one or more UL channel state information RSs; and receive, based at least in part on the first configuration message, at least one of one or more UL transmit RSs from one or more UEs or one more downlink (DL) RSs from one or more APs.

In some implementations of the method and apparatuses for a UE described herein, the first configuration message further includes at least one of a time period, a periodic time-domain behavior configuration, a semi-persistent time-domain behavior configuration, an aperiodic time-domain behavior configuration, a time-frequency resources configuration, an UL transmit RS pattern, one or more UL transmit beam indexes associated with a transmit beam pattern, or one or more DL receive beam indexes associated with a receive beam pattern; the first configuration message at least one of: classifies at least one UL transmit RS of a plurality of UL transmit RSs into at least one group of three groups, wherein an UL transmit RS of a first group of the three groups is designated for UE cell searching for a DL AP, an UL transmit RS of a second group of the three groups is designated for UE cell searching for an UL AP, and an UL transmit RS of a third group of the three groups is designated for an inter-UE CLI RS; associates at least one UL transmit RS of the plurality of UL transmit RSs with one or more of a traffic quality of service or a traffic priority class; or classifies at least one UL transmit RS of the plurality of UL transmit RSs into at least one of a cell common RS, a UE group common RS, or a UE specific RS each associated with one or more of a weight or a priority level; the first configuration message configures UE to report at least one of CLI measured quantity associated with the corresponding uplink transmit RS resource index, UL transmit beam index, downlink receive beam index, measurement subband index, or measurement resource index, wherein the CLI measured quantity comprises at least one of a CLI reference signal received power (RSRP) or CLI received signal strength indicator (RSSI).

In some implementations of the method and apparatuses for a UE described herein, the first configuration message configures the UE to at least one of: report an inter-UE CLI measured quantity based at least in part on the inter-UE CLI measured quantity being below or above a configured threshold; report one or more of a maximum or minimum inter-UE CLI measured quantity of a plurality of inter-UE CLI measured quantities; or report at least one inter-UE CLI measured quantity of a plurality of inter-UE CLI measured quantities by integrating the at least one inter-UE CLI measured quantity into one or more channel state information reported quantities; the first configuration message further includes a configuration for at least one of self-interference measurement and reporting resources or channel state information measurement and reporting resources each associated with at least one of a time period, a periodic, semi-persistent, or aperiodic time-domain behavior configuration, a time-frequency resources configuration, an UL transmit RS pattern, UL transmit RS beam indexes associated with a transmit beam pattern, or DL receive beam indexes associated with a receive beam pattern.

In some implementations of the method and apparatuses for a UE described herein, the first configuration message configures the UE to at least one of: report at least one of self-interference measured quantity associated with a corresponding UL transmit RS resource index, UL transmit beam index, DL receive beam index, measurement subband index, or measurement resource index, wherein the self-interference measured quantity includes at least one of a self-interference RS received power or a self-interference received signal strength indicator; report at least one self-interference measured quantity being below or above a configured threshold; report a maximum or minimum self-interference measured quantity of a plurality of self-interference measured quantities; report at least one self-interference measured quantity of a plurality of self-interference measured quantities by integrating the at least one self-interference measured quantity into one or more channel state information reported quantities; or report at least one of a channel state information measured quantity associated with a corresponding DL RS index, a measurement resource index, a measurement subband index, or an AP index; the at least one processor is configured to cause the UE to receive a second configuration message indicating at least one of a DL signal or channel configuration resources associated with at least one of a channel state information, a quasi-co-location or transmission configuration indicator state configuration, an UL signal or channel configuration resources associated with a channel state information, or quasi co-location or transmission configuration indicator state configuration; the second configuration message further includes at least one of assigned APs indexes and locations in DL mode, assigned APs indexes and locations in UL mode, or assigned APs indexes and locations in full-duplex (FD) mode, associated with an assignment period.

Some implementations of the method and apparatuses described herein may further include a processor for wireless communication to receive, from one or more APs, a first configuration message including one or more UL transmit RS resources, one or more inter-UE CLI measurement resources, and one or more inter-UE CLI reporting resources; transmit, based at least in part on the first configuration message, one or more UL transmit RSs including at least one of one or more inter-UE CLI RSs or one or more UL channel state information RSs; and receive, based at least in part on the first configuration message, at least one of one or more UL transmit RSs from one or more UEs or one more DL RSs from one or more APs.

In some implementations of the method and apparatuses for a processor described herein, the first configuration message further includes at least one of a time period, a periodic time-domain behavior configuration, a semi-persistent time-domain behavior configuration, an aperiodic time-domain behavior configuration, a time-frequency resources configuration, an UL transmit RS pattern, one or more UL transmit beam indexes associated with a transmit beam pattern, or one or more DL receive beam indexes associated with a receive beam pattern; the first configuration message at least one of: classifies at least one UL transmit RS of a plurality of UL transmit RSs into at least one group of three groups, wherein an UL transmit RS of a first group of the three groups is designated for UE cell searching for a DL AP, an UL transmit RS of a second group of the three groups is designated for UE cell searching for an UL AP, and an UL transmit RS of a third group of the three groups is designated for an inter-UE CLI RS; associates at least one UL transmit RS of the plurality of UL transmit RSs with one or more of a traffic quality of service or a traffic priority class; or classifies at least one UL transmit RS of the plurality of UL transmit RSs into at least one of a cell common RS, a UE group common RS, or a UE specific RS each associated with one or more of a weight or a priority level; the first configuration message configures UE to report at least one of CLI measured quantity associated with the corresponding uplink transmit RS resource index, UL transmit beam index, downlink receive beam index, measurement subband index, or measurement resource index, wherein the CLI measured quantity comprises at least one of a CLI RSRP or CLI RSSI.

In some implementations of the method and apparatuses for a processor described herein, the first configuration message configures the processor to at least one of: report an inter-UE CLI measured quantity based at least in part on the inter-UE CLI measured quantity being below or above a configured threshold; report one or more of a maximum or minimum inter-UE CLI measured quantity of a plurality of inter-UE CLI measured quantities; or report at least one inter-UE CLI measured quantity of a plurality of inter-UE CLI measured quantities by integrating the at least one inter-UE CLI measured quantity into one or more channel state information reported quantities; the first configuration message further includes a configuration for at least one of self-interference measurement and reporting resources or channel state information measurement and reporting resources each associated with at least one of a time period, a periodic, semi-persistent, or aperiodic time-domain behavior configuration, a time-frequency resources configuration, an UL transmit RS pattern, UL transmit RS beam indexes associated with a transmit beam pattern, or DL receive beam indexes associated with a receive beam pattern.

In some implementations of the method and apparatuses for a processor described herein, the first configuration message configures the processor to at least one of: report at least one of self-interference measured quantity associated with a corresponding UL transmit RS resource index, UL transmit beam index, DL receive beam index, measurement subband index, or measurement resource index, wherein the self-interference measured quantity includes at least one of a self-interference RS received power or a self-interference received signal strength indicator; report at least one self-interference measured quantity being below or above a configured threshold; report a maximum or minimum self-interference measured quantity of a plurality of self-interference measured quantities; report at least one self-interference measured quantity of a plurality of self-interference measured quantities by integrating the at least one self-interference measured quantity into one or more channel state information reported quantities; or report at least one of a channel state information measured quantity associated with a corresponding DL RS index, a measurement resource index, a measurement subband index, or an AP index; the at least one controller is configured to cause the processor to receive a second configuration message indicating at least one of a DL signal or channel configuration resources associated with at least one of a channel state information, a quasi-co-location or transmission configuration indicator state configuration, an UL signal or channel configuration resources associated with a channel state information, or quasi co-location or transmission configuration indicator state configuration; the second configuration message further includes at least one of assigned APs indexes and locations in DL mode, assigned APs indexes and locations in UL mode, or assigned APs indexes and locations in FD mode, associated with an assignment period.

Some implementations of the method and apparatuses described herein may further include a method performed by a UE, the method including receiving, from one or more APs, a first configuration message including one or more UL transmit RS resources, one or more inter-UE CLI measurement resources, and one or more inter-UE CLI reporting resources; transmitting, based at least in part on the first configuration message, one or more RSs including at least one of one or more inter-UE CLI RSs or one or more UL channel state information RSs; and receiving, based at least in part on the first configuration message, at least one of one or more UL transmit RSs from one or more UEs or one more DL RSs from one or more APs.

In some implementations of the method and apparatuses for a UE described herein, the first configuration message further includes at least one of a time period, a periodic time-domain behavior configuration, a semi-persistent time-domain behavior configuration, an aperiodic time-domain behavior configuration, a time-frequency resources configuration, an UL transmit RS pattern, one or more UL transmit beam indexes associated with a transmit beam pattern, or one or more DL receive beam indexes associated with a receive beam pattern; the first configuration message at least one of: classifies at least one UL transmit RS of a plurality of UL transmit RSs into at least one group of three groups, wherein an UL transmit RS of a first group of the three groups is designated for UE cell searching for a DL AP, an UL transmit RS of a second group of the three groups is designated for UE cell searching for an UL AP, and an UL transmit RS of a third group of the three groups is designated for an inter-UE CLI RS; associates at least one UL transmit RS of the plurality of UL transmit RSs with one or more of a traffic quality of service or a traffic priority class; or classifies at least one UL transmit RS of the plurality of UL transmit RSs into at least one of a cell common RS, a UE group common RS, or a UE specific RS each associated with one or more of a weight or a priority level; the configuration message configures UE to report at least one of CLI measured quantity associated with the corresponding uplink transmit RS resource index, UL transmit beam index, downlink receive beam index, measurement subband index, or measurement resource index, wherein the CLI measured quantity comprises at least one of a CLI reference signal received power (RSRP) or CLI received signal strength indicator (RSSI).

In some implementations of the method and apparatuses for a UE described herein, the first configuration message configures the UE to at least one of: report an inter-UE CLI measured quantity based at least in part on the inter-UE CLI measured quantity being below or above a configured threshold; report one or more of a maximum or minimum inter-UE CLI measured quantity of a plurality of inter-UE CLI measured quantities; or report at least one inter-UE CLI measured quantity of a plurality of inter-UE CLI measured quantities by integrating the at least one inter-UE CLI measured quantity into one or more channel state information reported quantities; the first configuration message further includes a configuration for at least one of self-interference measurement and reporting resources or channel state information measurement and reporting resources each associated with at least one of a time period, a periodic, semi-persistent, or aperiodic time-domain behavior configuration, a time-frequency resources configuration, an UL transmit RS pattern, UL transmit RS beam indexes associated with a transmit beam pattern, or DL receive beam indexes associated with a receive beam pattern.

In some implementations of the method and apparatuses for a UE described herein, the first configuration message configures the UE to at least one of: report at least one of self-interference measured quantity associated with a corresponding UL transmit RS resource index, UL transmit beam index, DL receive beam index, measurement subband index, or measurement resource index, wherein the self-interference measured quantity includes at least one of a self-interference RS received power or a self-interference received signal strength indicator; report at least one self-interference measured quantity being below or above a configured threshold; report a maximum or minimum self-interference measured quantity of a plurality of self-interference measured quantities; report at least one self-interference measured quantity of a plurality of self-interference measured quantities by integrating the at least one self-interference measured quantity into one or more channel state information reported quantities; or report at least one of a channel state information measured quantity associated with a corresponding DL RS index, a measurement resource index, a measurement subband index, or an AP index; receiving a second configuration message indicating at least one of a DL signal or channel configuration resources associated with at least one of a channel state information, a quasi-co-location or transmission configuration indicator state configuration, an UL signal or channel configuration resources associated with a channel state information, or quasi co-location or transmission configuration indicator state configuration; the second configuration message further includes at least one of assigned APs indexes and locations in DL mode, assigned APs indexes and locations in UL mode, or assigned APs indexes and locations in FD mode, associated with an assignment period.

Some implementations of the method and apparatuses described herein may further include a NE for wireless communication to transmit a first configuration message including one or more UL transmit RS resources, one or more inter-UE CLI measurement resources, and one or more inter-UE CLI reporting resources; receive one or more RSs including at least one of one or more UE UL RSs, one or more inter-AP CLI RSs, or one or more DL RSs; and transmit one or more RSs including at least one of one or more DL channel state information references signals or one or more inter-AP CLI RSs.

In some implementations of the method and apparatuses for a NE described herein, at least one processor is configured to cause the NE to receive a third configuration message including a slot configuration pattern configuring NE to operate in a DL mode, an UL mode, or a FD mode associated with at least one of a time period, one or more frequency resources, one or more time resources, a periodic time-domain behavior configuration, a semi-persistent time-domain behavior configuration, or a aperiodic time-domain behavior configuration; the third configuration message at least one of: configures the NE with at least one of a plurality of DL transmit RS resources or a plurality of inter-AP CLI measurement and reporting resources each associated with at least one of a time period, a periodic time-domain behavior configuration, a semi-persistent time-domain behavior configuration, or an aperiodic time-domain behavior configuration, a time-frequency resources configuration, a DL transmit RS pattern, one or more DL transmit beam indexes associated with a transmit beam pattern, or one or more UL beam indexes associated with a receive beam pattern; configures the NE to report at least one of a inter-AP CLI measured quantity associated with a corresponding DL transmit RS resource index, an UL receive beam index, a DL transmit beam index, a measurement subband index, or a measurement resource index, wherein the inter-AP CLI measured quantity includes one or more of a CLI RS received power or a CLI received signal strength indicator; configures the NE to report an inter-AP CLI measured quantity if that is below or above a configured threshold; configures the NE to report a maximum or minimum inter-AP CLI measured quantity of a plurality of CLI measured quantities; or configures the NE to report at least one inter-AP CLI measured quantity of a plurality of inter-AP CLI measured quantities by integrating the at least one inter-AP CLI measured quantity into an UL channel state information reported quantity.

In some implementations of the method and apparatuses for a NE described herein, the at least one processor is configured to cause the NE to receive a third configuration message including at least one of a plurality of self-interference measurement and reporting resources or a plurality of UL channel state information measurement and reporting resources each associated with at least one of a time period, a periodic time-domain behavior configuration, a semi-persistent time-domain behavior configuration, or an aperiodic time-domain behavior configuration, a time-frequency resources configuration, a DL transmit RS pattern, DL transmit beam indexes associated with a transmit beam pattern, or UL receive beam indexes associated with an receive beam pattern; the at least one processor is configured to cause the NE to receive a third configuration message configuring the NE to at least one of: report at least one self-interference measured quantity that is below or above a configured threshold; report a maximum or minimum self-interference measured quantity of a plurality of self-interference measured quantities; report at least one self-interference measured quantity of a plurality of self-interference measured quantities by integrating the at least one self-interference measured quantity into one or more UL channel state information reported quantities; or report at least one UL channel state information measured quantity associated with a corresponding UL transmit RS resource index, a measurement resource index, a measurement subband index, or an AP index.

In some implementations of the method and apparatuses for a NE described herein, the at least one processor is configured to cause the NE to receive a third configuration message classifying at least one configured DL transmit RS into one group of four groups, wherein a RS of a first group of the four groups is configured for indicating when the NE indicates a DL only mode, a RS of a second group of the four groups indicates an UL only mode, a RS of a third group of the four groups indicates a FD mode, and a RS of a fourth group of the four groups indicates an inter-AP CLI RS; the at least one processor is configured to cause the NE to transmit a predefined signal sequence to indicate a local communication direction assignment; the at least one processor is configured to cause the NE to receive a response message that one or more of: confirms, rejects, or reverts the local communication direction assignment; or indicates or configures at least one of UL signal resources or DL signal resources according to an indicated DL or UL mode; the at least one processor is configured to cause the NE to receive a third configuration message indicating an event-based measurement and reporting resources configuration associated with at least one of time-frequency resources, DL RS resources, UL RS resources, DL transmit beam indexes resources, UL receive beam indexes resources, inter-AP cross-link measurement resources, self-interference measurement resources, a time period, a periodic, or semi-persistent or aperiodic time-domain behavior configuration; the event-based measurement and reporting configuration indicates whether a difference in a first value of an L1-RS received power associated with an active beam and a second value of an L1-RS received power associated with an indicated beam is larger than a configured threshold, and wherein the at least one processor is configured to cause the NE to transmit an indication of whether an event occurred via a configured contention-based RS resource or a contention-free RS resource.

Some implementations of the method and apparatuses described herein may further include a method performed by a NE, the method including transmitting a first configuration message including one or more UL transmit RS resources, one or more inter-UE CLI measurement resources, and one or more inter-UE CLI reporting resources; receiving one or more RSs including at least one of one or more UE UL RSs, one or more inter-AP CLI RSs, or one or more DL RSs; and transmitting one or more RSs including at least one of one or more DL channel state information references signals or one or more inter-AP CLI RSs.

In some implementations of the method and apparatuses for a NE described herein, the method further comprising receiving a third configuration message including a slot configuration pattern configuring network equipment to operate in a DL mode, an UL mode, or a FD mode associated with at least one of a time period, one or more frequency resources, one or more time resources, a periodic time-domain behavior configuration, a semi-persistent time-domain behavior configuration, or a aperiodic time-domain behavior configuration; the third configuration message at least one of: configures the NE with at least one of a plurality of DL transmit RS resources or a plurality of inter-AP CLI measurement and reporting resources each associated with at least one of a time period, a periodic time-domain behavior configuration, a semi-persistent time-domain behavior configuration, or an aperiodic time-domain behavior configuration, a time-frequency resources configuration, a DL transmit RS pattern, one or more DL transmit beam indexes associated with a transmit beam pattern, or one or more UL beam indexes associated with a receive beam pattern; configures the NE to report at least one of a inter-AP CLI measured quantity associated with a corresponding DL transmit RS resource index, an UL receive beam index, a DL transmit beam index, a measurement subband index, or a measurement resource index, wherein the inter-AP CLI measured quantity includes one or more of a CLI RS received power or a CLI received signal strength indicator; configures the NE to report an inter-AP CLI measured quantity if that is below or above a configured threshold; configures the NE to report a maximum or minimum inter-AP CLI measured quantity of a plurality of CLI measured quantities; or configures the NE to report at least one inter-AP CLI measured quantity of a plurality of inter-AP CLI measured quantities by integrating the at least one inter-AP CLI measured quantity into an UL channel state information reported quantity.

In some implementations of the method and apparatuses for a NE described herein, the method further comprising receiving a third configuration message including at least one of a plurality of self-interference measurement and reporting resources or a plurality of UL channel state information measurement and reporting resources each associated with at least one of a time period, a periodic time-domain behavior configuration, a semi-persistent time-domain behavior configuration, or an aperiodic time-domain behavior configuration, a time-frequency resources configuration, a DL transmit RS pattern, DL transmit beam indexes associated with a transmit beam pattern, or UL receive beam indexes associated with an receive beam pattern; receiving a third configuration message configuring the NE to at least one of: report at least one self-interference measured quantity that is below or above a configured threshold; report a maximum or minimum self-interference measured quantity of a plurality of self-interference measured quantities; report at least one self-interference measured quantity of a plurality of self-interference measured quantities by integrating the at least one self-interference measured quantity into one or more UL channel state information reported quantities; or report at least one UL channel state information measured quantity associated with a corresponding UL transmit RS resource index, a measurement resource index, a measurement subband index, or an AP index; receiving a third configuration message classifying at least one configured DL transmit RS into one group of four groups, wherein a RS of a first group of the four groups is configured for indicating when the NE indicates a DL only mode, a RS of a second group of the four groups indicates an UL only mode, a RS of a third group of the four groups indicates a FD mode, and a RS of a fourth group of the four groups indicates an inter-AP CLI RS.

In some implementations of the method and apparatuses for a NE described herein, the method further comprising transmitting a predefined signal sequence to indicate a local communication direction assignment; receiving a response message that one or more of: confirms, rejects, or reverts the local communication direction assignment; or indicates or configures at least one of UL signal resources or DL signal resources according to an indicated DL or UL mode; receiving a third configuration message indicating an event-based measurement and reporting resources configuration associated with at least one of time-frequency resources, DL RS resources, UL RS resources, DL transmit beam indexes resources, UL receive beam indexes resources, inter-AP cross-link measurement resources, self-interference measurement resources, a time period, a periodic, or semi-persistent or aperiodic time-domain behavior configuration; the event-based measurement and reporting configuration indicates whether a difference in a first value of an L1-RS received power associated with an active beam and a second value of an L1-RS received power associated with an indicated beam is larger than a configured threshold, and wherein the method further includes transmitting an indication of whether an event occurred via a configured contention-based RS resource or a contention-free RS resource.

### BRIEF DESCRIPTION OF THE DRAWINGS

FIG. 1 illustrates an example of a wireless communications system in accordance with aspects of the present disclosure.

FIG. 2 illustrates an example cell-free massive MIMO system 200.

FIG. 3 illustrates an example AP classification scenario 300.

FIG. 4 illustrates an example AP classification scenario 400.

FIG. 5 illustrates an example AP classification scenario 500.

FIG. 6 illustrates an example of a UE 600 in accordance with aspects of the present disclosure.

FIG. 7 illustrates an example of a processor 700 in accordance with aspects of the present disclosure.

FIG. 8 illustrates an example of a NE 800 in accordance with aspects of the present disclosure.

FIG. 9 illustrates a flowchart of a method 900 in accordance with aspects of the present disclosure.

FIG. 10 illustrates a flowchart of a method 1000 in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. One proposal for next generation wireless communications systems are cell-free massive MIMO networks, also known as distributed massive MIMO networks. In cell-free massive MIMO networks, multiple geographically distributed APs can cooperate through a central processing unit (CPU) to serve a number of UEs in both UL (UL) and DL (DL), e.g., in a coherent or non-coherent manner. Compared to co-located massive MIMO, cell-free massive MIMO networks can improve spectral efficiency, network capacity, and network coverage, e.g., by exploiting favorable propagation and diversity gains.

Some implementations of cell-free massive MIMO networks utilize time division duplexing (TDD) for reciprocity-based channel training. For instance, in a given time period, network APs can operate either in DL mode (e.g., transmitting to UEs) or UL mode, e.g., receiving from UEs. However, such implementations can limit network flexibility and may be unable to accommodate heterogenous UL and DL data requirements by the UEs, which may cause unintended delay and/or latency.

One solution to such challenges is for the network to assign APs to UL and DL modes in an adaptive fashion based on channel, interference, and/or traffic conditions to resemble and/or enable FD communications. For instance, a network can be enabled to receive and transmit signals at the same time over non overlapping, partially overlapping, and/or fully overlapping frequency resources. Considering, for example, a cell-free network to be a large MIMO array whose antennas are distributed over an area, a FD realization of this array can be enabled.

Aspects of the present disclosure are described in the context of a wireless communications system, and include different implementations and signaling design for cell-free massive MIMO networks to enable a network CPU and/or CPUs to determine DL and UL assignment and/or configuration for APs in a centralized, distributed, and/or decentralized manner based on criteria such as channel conditions, interference conditions, and/or traffic conditions. Examples of interference conditions include AP-to-UE (e.g., DL based) interference, UE-to-AP (e.g., UL based) interference, inter-AP CLI (CLI), inter-UE CLI, self-interference at FD-capable AP and/or FD-capable UE, etc.

In one or more implementations such as in a centralized scheme, a CPU can control UL-DL communication direction assignment of APs by coordinating configurations of DL and UL RSs, measurement, and reporting resources to obtain information regarding channel, interference, and traffic conditions between different UEs and APs. In alternative or additional implementations such as in a distributed and/or decentralized-based scheme, a CPU can control UL-DL communication direction assignment by coordinating configurations of DL and UL RSs, measurement, and reporting resources to obtain at least partial information regarding channel, interference, and traffic conditions between different UEs and APs. In at least some scenarios, one or more flexible APs are configured to determine and/or indicate their communication direction assignment locally, such as via handshake signaling with the CPU based at least on part on AP local measurements, received reports from UEs, and/or received side-information and/or measurements from CPU.

By performing the described techniques, devices in a wireless communications system can reduce fronthaul signaling and/or backhaul signaling and reduce UL and DL communications latency.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

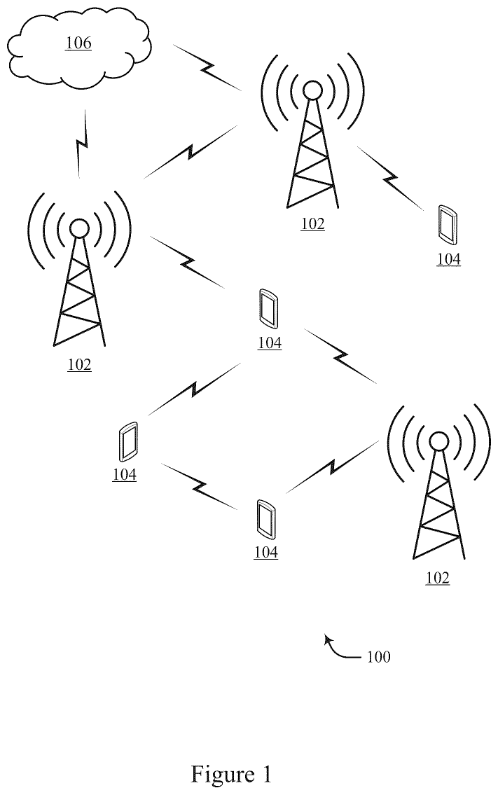

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives, from one or more NEs 102 (e.g., one or more APs), a first configuration message comprising one or more UL transmit RS resources, one or more inter-UE CLI measurement resources, and one or more inter-UE CLI reporting resources. The UE 104 transmits, based at least in part on the first configuration message, one or more UL transmit RSs comprising at least one of one or more inter-UE CLI RSs or one or more UL channel state information RSs. The UE receives, based at least in part on the first configuration message, at least one of one or more UL transmit RSs from one or more UEs or one more DL RSs from one or more APs.

According to implementations, a NE 102 (e.g., an AP) transmits a first configuration message comprising one or more UL transmit RS resources, one or more inter-UE CLI measurement resources, and one or more inter-UE CLI reporting resources. The NE 102 receives one or more RSs comprising at least one of one or more UE UL RSs, one or more inter-AP CLI RSs, or one or more DL RSs. The NE 102 transmits one or more RSs comprising at least one of one or more DL channel state information references signals or one or more inter-AP CLI RSs.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

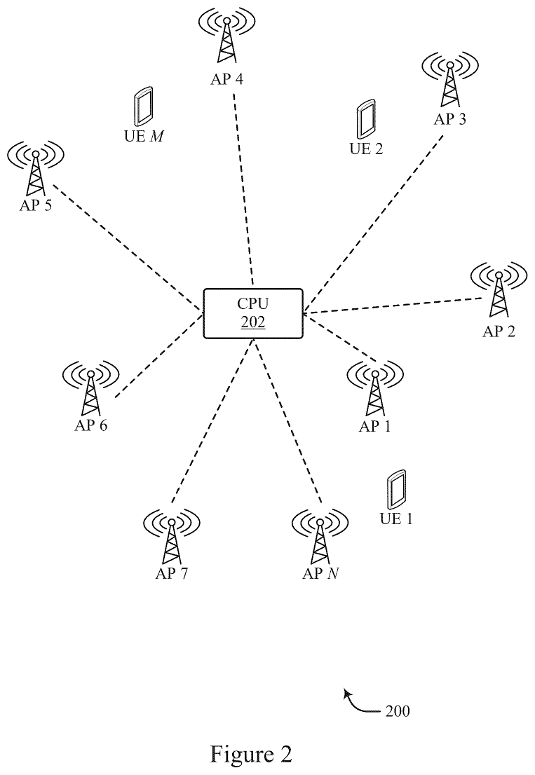

FIG. 2 illustrates an example cell-free massive MIMO system 200. The system 200, for example, includes a CPU 202, N APs, and M UEs. The CPU 202, for instance, connects to the APs (which can also represent transmission reception points (TRPS)) and can control DL and UL assignment of each of the N APs. Each AP can have one or more antenna elements distributed on one or more of antenna panels. The APs can connect to the CPU 202 using fast and high-capacity fronthaul and backhaul connections that enable accurate time-frequency synchronizations and access and control communications. The system 200 can be considered a FD capable network where the network assigns DL only APs for DL communications, UL only APs for UL communications, and APs for joint DL and UL communications, e.g., FD capable APs.

According to implementations, a FD capable AP represents a wireless network node (e.g., an AP, a UE) that is considered FD capable (e.g., capable of simultaneous reception and transmission) if the node can suppress self-interference (SI) to a certain level, e.g., below-or-equal-to the thermal noise power level. SI suppression can be done via a combination of various techniques, e.g., antenna and frequency-domain isolation, analog and digital filtering techniques, etc.

In at least some implementations, an AP DL-UL assignment can be fixed, e.g., at time of installation based on AP hardware specification, field testing, offline measurements, etc. Alternatively or additionally, an AP DL-UL assignment can be performed adaptively, e.g., based on channels, interference conditions, traffic conditions, etc. Interference conditions, for instance, can include AP-to-UE (e.g., DL-based) interference, UE-to-AP (e.g., UL-based) interference, inter-AP CLI, inter-UE CLI, self-interference at FD-capable AP and/or FD-capable UE, etc. Compared to fixed AP DL-UL assignment schemes, an adaptive AP DL-UL assignment scheme can improve system spectral and energy efficiencies and reduce DL and UL latencies. Adaptive AP DL-UL assignment can be classified into centralized and distributed/decentralized schemes. For instance, in a centralized scheme, the CPU can perform AP DL-UL assignment based on factors such as channel information, interference, and traffic conditions. In a distributed and/or decentralized scheme, some APs can determine their AP DL-UL assignment based on AP locally obtained measurements and/or reports with a possible handshake with the CPU for, e.g., assignment acknowledgement/negative-acknowledgement (ACK/NACK).

In one or more implementations, the assignment of APs to DL and UL operation (e.g., AP DL-UL assignment) can be done in a transparent and/or non-transparent fashion with respect to a UE that is connected to the network. In a transparent mode, the UE may be unaware of the assignment of DL and UL APs and the UE can transmit to and/or receive from the network without explicitly knowing with which APs it is communicating. In a non-transparent mode a UE may know which APs are transmitting towards the UE in DL and which APs receive from the UE in the UL. Compared to transparent assignment, the UE can utilize some information in the non-transparent APs assignment to perform more efficient UL and/or DL communications, such as in beam management (e.g., beam recovery, beam failure) and/or mobility scenarios. For example, in at least some implementations, each AP may be physically configured to point to a specific area in two-dimensional (2D) and/or 3D dimensions, where the antenna array gain can be increasingly maximized as compared to other areas. In these areas, the DL/UL communications can be performed using line-of-sight (LOS)-based (or dominant) channels with high probability. Thus, non-transparent APs assignment can assist in fast selection of UL transmit beam and/or DL receive beam. In other words, non-transparent AP assignment can facilitate location-based communications, where a UE can estimate and/or track its coarse location using location-estimation methods (e.g., GPS and/or wireless-based methods) and use the UEs location to perform efficient and fast UL-DL communications.

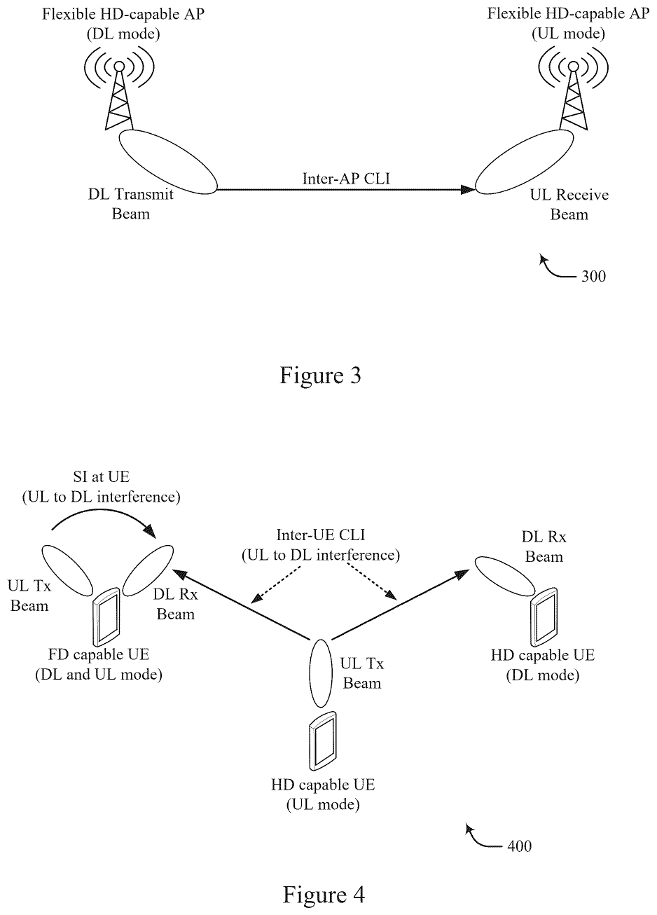

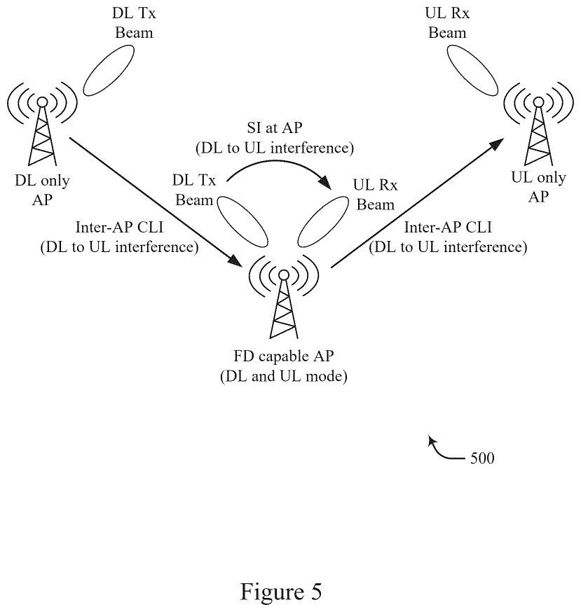

FIG. 3 illustrates an example AP classification scenario 300, FIG. 4 illustrates an example AP classification scenario 400, and FIG. 5 illustrates an example AP classification scenario 500. In the scenarios 300-500, for instance, a DL-only AP can be an AP capable of or assigned only for DL communications, an UL-only AP can be an AP capable of or assigned only for UL communications, a flexible half-duplex (HD)-capable AP can be an AP capable of DL and UL communications (e.g., not simultaneously), and a flexible FD-capable AP can be an AP capable of DL and UL communications simultaneously.

In at least some implementations, a CPU may initially classify the APs into DL-only APs, UL-only APs, flexible HD-capable APs (e.g., AP capable of transmit and receive, but not simultaneously), and flexible FD-capable APs (e.g., AP capable of transmit and receive simultaneously), such as illustrated in the scenarios 300-500. The AP classification can be a fixed classification (e.g., due to hardware specifications) and/or via signaling configurations, e.g., by providing DL-only slot configurations to DL-only APs, UL-only slot configurations to UL-only APs, and flexible slot configurations to flexible HD/FD-capable APs.

In at least some examples, each slot configuration may be associated with a time period, continuous and/or non-continuous frequency and/or time resources (e.g., non-overlapping frequency resources, partial overlapping frequency resources, and/or full overlapping frequency resources), a transmit and/or receive beam pattern and/or beam indexes, etc. In at least some examples, a signaling configuration indicating the classification of an AP in the plurality of APs may correspond to an aperiodic behavior (e.g., an AP is configured as one of DL, UL, or flexible AP for a one period of time) or periodic behavior, e.g., an AP is configured as one or more of DL, UL, or flexible AP in alternating periods of time.

In at least some implementations, a UE can receive from the network (e.g., CPU) a configuration message, e.g., via system information block (SIB), radio resource control (RRC), and/or DL control information (DCI) signaling. The configuration message, for instance, indicates and configures (e.g., based on the UE capability information) a plurality of UL transmit (Tx) RSs (RS) resources (e.g., sounding reference signal (SRS), preambles), self-interference measurement and reporting resources, inter-UE CLI measurement and reporting resources, and/or channel state information (CSI) measurement and reporting resources. Further, each of the configured resources can be associated with at least one of a time period, a time-domain behavior (e.g., periodic, semi-persistent or aperiodic), time-frequency resource configurations, an UL Tx RSs pattern, an UL Tx beams indexes set (e.g., spatial filters indexes) associated with a beam-pattern, and/or DL receive (Rx) beams indexes set (e.g., spatial filters indexes) associated with a beam-pattern.

In at least some implementations, the configured DL Rx beams can be the same as the UL Tx beams, but with a different beam pattern. In some alternative or additional examples, the DL Rx beams can be the same as the DL Rx beams via which the UE receives the network DL synchronization signal and physical broadcast channel (PBCH) block (SSB) Tx beams, e.g., best K≥1 DL Rx beams used and/or determined during an initial random-access procedure.

In at least some implementations, a configuration message can classify one or more of the configured and/or indicated UL Tx RSs into two groups, one group to be used when a UE is cell searching for DL APs and another group when a UE is cell searching for UL APs. The different groups of UL Tx RSs can be used, e.g., to facilitate AP assignment based on UE parameters.

In at least some implementations, a configuration message can classify one or more of the configured and/or indicated UL Tx RSs into three classes as cell-common RSs, UE group-common RSs, and UE-specific RSs. The classification can be explicit as indicated by the configuration message or implicit using the configuration message container, e.g., SIB for cell-common UL RSs, RRC for UE group-common and/or UE-specific UL RSs, and DCI or medium access control (MAC) control elements (CE) triggering for UE-specific UL RSs. In one or more examples, the different classes can be prioritized and associated with a weight and/or priority level which can be used by a network scheduler when determining the AP assignment. For instance, cell and/or group common UL RSs can have higher weights than UE-specific UL RSs, or vice-versa. In at least some examples, the configuration message can associate one or more of the configured and/or indicated UL Tx RSs with a specific traffic quality of service (QOS) and/or priority class, e.g., high priority traffic, low priority traffic, etc. In at least some implementations the configuration message configures UE to report at least one of CLI measured quantity associated with the corresponding uplink transmit RS resource index, UL transmit beam index, downlink receive beam index, measurement subband index, or measurement resource index, wherein the CLI measured quantity comprises at least one of a CLI RSRP or CLI RSSI.

In at least some implementations, a configuration message configures and/or indicates to a UE to report one or more of: the M_{CSI}≥1 CSI measured quantities (e.g., CSI reference signal received power (RSRP), CSI channel quality indicator (CQI), CSI signal-to-interference-and-noise ratio (SINR), CSI rank indicator (RI), CSI precoder matrix indicator (PMI), SSB RSRP) each associated with the corresponding DL RS index (e.g., SSB or CSI-RS), measurement resource index, measurement subband index, and/or AP index; the M_{SI}≥1 SI measured quantities (e.g., SI RSRP, SI received signal strength indicator (RSSI)) each associated with the corresponding UL Tx RS resource index, UL Tx beam index, DL Rx beam index, measurement subband index, and/or measurement resource index; and/or the M_{CLI}≥1 inter-UE CLI measured quantities (e.g., CLI RSRP, CLI RSSI) each associated with the corresponding UL Tx RS resource index, UL Tx beam index, DL Rx beam index, measurement subband index, and/or measurement resource index.

In at least some implementations, a configuration message can indicate to a UE to report the CSI measured quantities, the self-interference measured quantities, and/or the inter-UE CLI measured quantities that are below or above a configured/indicated threshold, e.g., a maximum or minimum quantity. In at least some implementations, the configuration message can indicate to a UE to report the CSI/SI/CLI quantities with a certain ordering, e.g., based on quantity values as lowest and/or highest first and/or based on the corresponding RS index, measurement resource index, UE index, and/or AP index. In at least some implementations, the configuration message can indicate to UE to report one or more of self-interference and/or inter-UE CLI measured quantities by embedding and/or integrating the quantities into one or more of CSI report quantities, e.g., into CSI RSRP, CSI CQI, CSI SINR, etc.

In at least some implementations, a UE can transmit one or more of UL RSs and/or receives one or more of DL and/or CLI RSs based at least on part of a configuration message. The UE can measure, determine, and/or quantify one or more of CSI quantities, SI quantities, and/or inter-UE CLI quantities and generate one or more of CSI reports, SI reports, and/or inter-UE CLI reports based at least on part of the configuration message. Further, the UE can transmit the generated one or more of CSI reports (e.g., over physical UL shared channel (PUSCH) and/or physical UL control channel (PUCCH) resources), SI reports, and/or inter-UE CLI reports to the network based at least on part of the configuration message. In at least some examples, the configuration message can indicate to the UE to report the CSI, SI, CLI reports with a certain ordering and/or priority.

In implementations of the present disclosure and considering network side scenarios, UL RS and/or reports can be received by network APs using one or more of configured and/or indicated UL Rx beams. In at least some implementations, APs can be configured with the same UL Rx beams set, UL Rx beam pattern, DL Tx RSs resources, DL Tx RSs pattern, DL Tx beams indexes set, and/or DL Tx beam pattern. Alternatively or additionally, the CPU can configure one or more APs with specific UL Rx beams set, UL Rx beam pattern, DL Tx RSs resources, DL Tx RSs pattern, DL Tx beams indexes set, and/or DL Tx beam pattern. The configuration, for instance, can be determined based on inter-AP CLI measurements, APs location, and/or AP area of interest.

In at least some implementations, each AP can listen for, receive, and/or measure the transmitted UL RSs, inter-AP CLI RSs, AP self-interference, and/or UE reports. Alternatively or additionally, a subset of the APs listen for, receive, and/or measure the transmitted UL RSs, AP self-interference, inter-AP CLI RSs, and/or UE reports, The subset, for instance, can be based on AP classification (e.g., DL-only APs, UL-only APs, and/or flexible APs) and/or based on an explicit indication by CPU. In at least some examples, the CPU can initially cluster the APs and assign a primary AP for each cluster that is responsible for listening for, receiving, and/or measuring the transmitted UL RSs, AP self-interference, inter-AP CLI RSs, and/or UE reports. In one or more examples, for each AP receiving and/or measuring UL RSs, AP self-interference, and/or inter-AP CLI RSs, the AP can use one or more performance metrics (e.g., RSRP, RSSI) to measure, determine, and/or quantify the quality of received UL RSs, AP self-interference, and/or inter-AP CLI.

In at least some implementations (e.g., in a centralized decision scenario), one or more APs can forward and/or transmit (e.g., via fronthaul Xn/F1 connections, wirelessly via control links and/or channels) one or more of: measured UL CSI/RSs quantities (e.g., UL RSRP, UL RSSI, UL CQI, UL SINR, UL RI) associated with one or more of UL RSs indexes, UL RSs group indexes, UL RSs class indexes, and/or UL RSs measurement resources indexes; measured inter-AP CLI quantities (e.g., CLI RSRP, CLI RSSI) associated with AP inter-AP CLI RSs resources indexes, inter-AP CLI Tx beams indexes, inter-AP CLI Rx beam indexes, APs indexes, and/or inter-AP CLI measurement resources indexes; and/or received CSI reports, UEs self-interference reports, and/or inter-UEs CLI reports.

In at least some implementations, an AP can be configured by a CPU to forward and/or transmit a processed version of the received measurements and/or reports, e.g., based on a quantization and/or a higher layer filtering process. In at least some examples, an AP can be configured and/or indicated to forward and/or transmit one or more AP measurements and/or received reports if a configured and/or indicated condition and/or threshold is met. Examples of such conditions and/or thresholds include: if an UL RS, inter-AP CLI, and/or AP SI quality metric is above a predefined and/or configured threshold (e.g., which can reduce signaling); and/or if a received UL RS index belongs to a specific group and/or class, e.g., in cases where a corresponding AP is pre-determined to serve a specific UL or DL direction.

In at least some implementations, a CPU can determine an AP UL-DL assignment based at least in part on one or more of: received measurements, APs indication messages/reports, and/or UE reports; an APs distribution and/or location; and/or UE traffic demand.

In at least some implementations (e.g., in distributed and/or decentralized decision scenarios), one or more flexible APs can be configured to determine and/or indicate their communication direction assignment locally, with possible handshake signaling with the CPU based at least on part of AP local measurements, received reports from UEs, and/or received side-information/measurements from CPU, e.g., one or more of inter-AP CLI quantities.

In at least some implementations, the network (e.g., via the CPU) can configure an AP to monitor a set of events (e.g., based on UL RSs, DL RSs, or a combination thereof) received at the AP. The AP can feed back an outcome of the event monitoring process to the CPU, e.g., in periodic, semi-persistent, and/or aperiodic manner. In at least one example, the AP is configured to monitor an event based at least in part on whether a difference in a first value of an L1-RSRP associated with an active beam and a second value of an L1-RSRP associated with an indicated beam is larger than a configured threshold, and the AP can signal to the CPU whether the event occurred via a configured contention-based or contention free resources.

In at least some implementations, a flexible AP may indicate its local communication direction assignment (e.g., UL, DL, or both) to a CPU by transmitting a predefined signal sequence, e.g., a binary signal, e.g., 0 for UL and 1 for DL associated with AP index. In at least some examples, the CPU can configure a flexible AP with two or three groups of (DL) Tx RSs, one group to be used when the AP is indicating its DL assignment, a second group when the AP is indicating its UL assignment, and a third group when the AP is indicating its FD assignment. The AP may receive a response from the CPU confirming, rejecting, or reverting the local assignment.

In at least some implementations, an AP can feed back side-information to the CPU comprising an indicator of a recommended UL/DL communication direction. The CPU in response may configure the AP with UL and/or DL resources according to the recommended UL/DL communication direction.

In at least some implementations such as for centralized and distributed assignment techniques, a CPU can transmit a configuration message to the UE using one or more of assigned DL APs. The configuration message can indicate at least one of: a configuration message for a DL signal and/or channel associated with a CSI, quasi co-location (QCL), and/or transmission configuration indicator (TCI)-state configuration; a configuration message for an UL signal and/or channel associated with a CSI, QCL, and/or TCI-state configuration; assigned DL APs indexes/locations (absolute/relative location)/assignment period; and/or assigned UL APs indexes/locations (absolute/relative location)/assignment period. In at least some examples the AP assignment period can be specified in terms of number of symbols, slots, subframes, and/or frames and/or a time-value (e.g., in milliseconds), during which the UEs can determine that the given, received, and/or configured assignments are fixed. In at least some examples, the AP assignment period can be based on an alternating time-domain behavior, e.g., uniform alternating periods of UL assignment and DL assignment of the AP.

In at least some implementations, the AP location can be the absolute location, e.g., real physical location, relative location to a UE, and/or location relative to a reference location indicated in the configuration message. In at least some examples, the AP location can correspond to and/or be associated with an indicated UL beam index and/or a DL beam index. In at least some examples, the configuration message indicates one or more preferred and/or assigned UL Tx beam indexes. In at least some examples, the UE receives a DL signal and/or channel and/or transmits an UL signal and/or channel based at least on part of the configuration message.

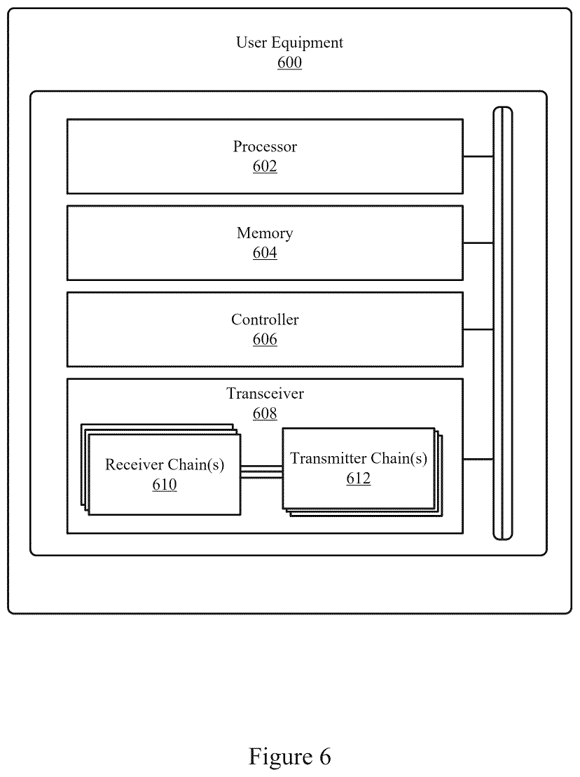

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving, from one or more APs, a first configuration message including one or more UL transmit RS resources, one or more inter-UE CLI measurement resources, and one or more inter-UE CLI reporting resources; transmitting, based at least in part on the first configuration message, one or more UL transmit RSs including at least one of one or more inter-UE CLI RSs or one or more UL channel state information RSs; and receiving, based at least in part on the first configuration message, at least one of one or more UL transmit RSs from one or more UEs or one more DL RSs from one or more APs.

Additionally, the UE 600 may be configured to support any one or combination of where the first configuration message further includes at least one of a time period, a periodic time-domain behavior configuration, a semi-persistent time-domain behavior configuration, an aperiodic time-domain behavior configuration, a time-frequency resources configuration, an UL transmit RS pattern, one or more UL transmit beam indexes associated with a transmit beam pattern, or one or more DL receive beam indexes associated with a receive beam pattern; the first configuration message at least one of: classifies at least one UL transmit RS of a plurality of UL transmit RSs into at least one group of three groups, wherein an UL transmit RS of a first group of the three groups is designated for UE cell searching for a DL AP, an UL transmit RS of a second group of the three groups is designated for UE cell searching for an UL AP, and an UL transmit RS of a third group of the three groups is designated for an inter-UE CLI RS; associates at least one UL transmit RS of the plurality of UL transmit RSs with one or more of a traffic quality of service or a traffic priority class; or classifies at least one UL transmit RS of the plurality of UL transmit RSs into at least one of a cell common RS, a UE group common RS, or a UE specific RS each associated with one or more of a weight or a priority level; the first configuration message configures UE to report at least one of CLI measured quantity associated with the corresponding uplink transmit RS resource index, UL transmit beam index, downlink receive beam index, measurement subband index, or measurement resource index, wherein the CLI measured quantity comprises at least one of a CLI RSRP or CLI RSSI.

Additionally, the UE 600 may be configured to support any one or combination of where the first configuration message configures the UE to at least one of: report an inter-UE CLI measured quantity based at least in part on the inter-UE CLI measured quantity being below or above a configured threshold; report one or more of a maximum or minimum inter-UE CLI measured quantity of a plurality of inter-UE CLI measured quantities; or report at least one inter-UE CLI measured quantity of a plurality of inter-UE CLI measured quantities by integrating the at least one inter-UE CLI measured quantity into one or more channel state information reported quantities; the first configuration message further includes a configuration for at least one of self-interference measurement and reporting resources or channel state information measurement and reporting resources each associated with at least one of a time period, a periodic, semi-persistent, or aperiodic time-domain behavior configuration, a time-frequency resources configuration, an UL transmit RS pattern, UL transmit RS beam indexes associated with a transmit beam pattern, or DL receive beam indexes associated with a receive beam pattern.

Additionally, the UE 600 may be configured to support any one or combination of where the first configuration message configures the UE to at least one of: report at least one of self-interference measured quantity associated with a corresponding UL transmit RS resource index, UL transmit beam index, DL receive beam index, measurement subband index, or measurement resource index, wherein the self-interference measured quantity includes at least one of a self-interference RS received power or a self-interference received signal strength indicator; report at least one self-interference measured quantity being below or above a configured threshold; report a maximum or minimum self-interference measured quantity of a plurality of self-interference measured quantities; report at least one self-interference measured quantity of a plurality of self-interference measured quantities by integrating the at least one self-interference measured quantity into one or more channel state information reported quantities; or report at least one of a channel state information measured quantity associated with a corresponding DL RS index, a measurement resource index, a measurement subband index, or an AP index; receiving a second configuration message indicating at least one of a DL signal or channel configuration resources associated with at least one of a channel state information, a quasi-co-location or transmission configuration indicator state configuration, an UL signal or channel configuration resources associated with a channel state information, or quasi co-location or transmission configuration indicator state configuration; the second configuration message further includes at least one of assigned APs indexes and locations in DL mode, assigned APs indexes and locations in UL mode, or assigned APs indexes and locations in FD mode, associated with an assignment period.

Additionally, or alternatively, the UE 600 may support at least one memory (e.g., the memory 604) and at least one processor (e.g., the processor 602) coupled with the at least one memory and configured to cause the UE to receive, from one or more APs, a first configuration message including one or more UL transmit RS resources, one or more inter-UE CLI measurement resources, and one or more inter-UE CLI reporting resources; transmit, based at least in part on the first configuration message, one or more UL transmit RSs including at least one of one or more inter-UE CLI RSs or one or more UL channel state information RSs; and receive, based at least in part on the first configuration message, at least one of one or more UL transmit RSs from one or more UEs or one more DL RSs from one or more APs.

Additionally, the UE 600 may be configured to support any one or combination of where the first configuration message further includes at least one of a time period, a periodic time-domain behavior configuration, a semi-persistent time-domain behavior configuration, an aperiodic time-domain behavior configuration, a time-frequency resources configuration, an UL transmit RS pattern, one or more UL transmit beam indexes associated with a transmit beam pattern, or one or more DL receive beam indexes associated with a receive beam pattern; the first configuration message at least one of: classifies at least one UL transmit RS of a plurality of UL transmit RSs into at least one group of three groups, wherein an UL transmit RS of a first group of the three groups is designated for UE cell searching for a DL AP, an UL transmit RS of a second group of the three groups is designated for UE cell searching for an UL AP, and an UL transmit RS of a third group of the three groups is designated for an inter-UE CLI RS; associates at least one UL transmit RS of the plurality of UL transmit RSs with one or more of a traffic quality of service or a traffic priority class; or classifies at least one UL transmit RS of the plurality of UL transmit RSs into at least one of a cell common RS, a UE group common RS, or a UE specific RS each associated with one or more of a weight or a priority level; the first configuration message configures UE to report at least one of CLI measured quantity associated with the corresponding uplink transmit RS resource index, UL transmit beam index, downlink receive beam index, measurement subband index, or measurement resource index, wherein the CLI measured quantity comprises at least one of a CLI RSRP or CLI RSSI.

Additionally, the UE 600 may be configured to support any one or combination of where the first configuration message configures the UE to at least one of: report an inter-UE CLI measured quantity based at least in part on the inter-UE CLI measured quantity being below or above a configured threshold; report one or more of a maximum or minimum inter-UE CLI measured quantity of a plurality of inter-UE CLI measured quantities; or report at least one inter-UE CLI measured quantity of a plurality of inter-UE CLI measured quantities by integrating the at least one inter-UE CLI measured quantity into one or more channel state information reported quantities; the first configuration message further includes a configuration for at least one of self-interference measurement and reporting resources or channel state information measurement and reporting resources each associated with at least one of a time period, a periodic, semi-persistent, or aperiodic time-domain behavior configuration, a time-frequency resources configuration, an UL transmit RS pattern, UL transmit RS beam indexes associated with a transmit beam pattern, or DL receive beam indexes associated with a receive beam pattern.

Additionally, the UE 600 may be configured to support any one or combination of where the first configuration message configures the UE to at least one of: report at least one of self-interference measured quantity associated with a corresponding UL transmit RS resource index, UL transmit beam index, DL receive beam index, measurement subband index, or measurement resource index, wherein the self-interference measured quantity includes at least one of a self-interference RS received power or a self-interference received signal strength indicator; report at least one self-interference measured quantity being below or above a configured threshold; report a maximum or minimum self-interference measured quantity of a plurality of self-interference measured quantities; report at least one self-interference measured quantity of a plurality of self-interference measured quantities by integrating the at least one self-interference measured quantity into one or more channel state information reported quantities; or report at least one of a channel state information measured quantity associated with a corresponding DL RS index, a measurement resource index, a measurement subband index, or an AP index; the at least one processor is configured to cause the UE to receive a second configuration message indicating at least one of a DL signal or channel configuration resources associated with at least one of a channel state information, a quasi-co-location or transmission configuration indicator state configuration, an UL signal or channel configuration resources associated with a channel state information, or quasi co-location or transmission configuration indicator state configuration; the second configuration message further includes at least one of assigned APs indexes and locations in DL mode, assigned APs indexes and locations in UL mode, or assigned APs indexes and locations in FD mode, associated with an assignment period.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

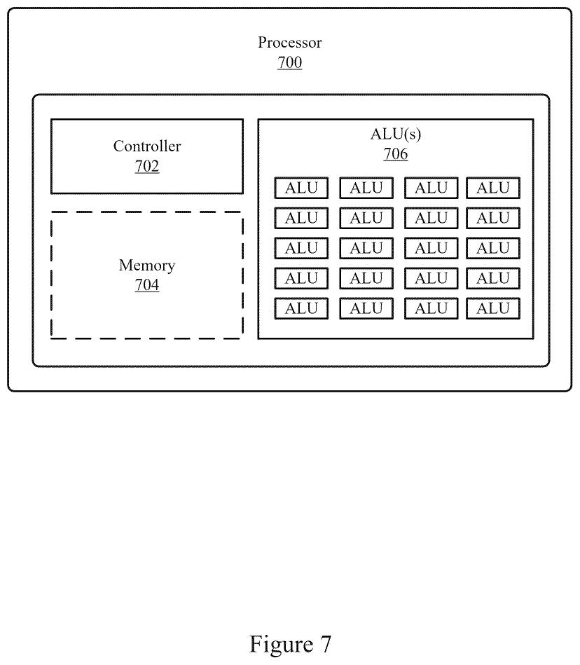

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive, from one or more APs, a first configuration message including one or more UL transmit RS resources, one or more inter-UE CLI measurement resources, and one or more inter-UE CLI reporting resources; transmit, based at least in part on the first configuration message, one or more UL transmit RSs including at least one of one or more inter-UE CLI RSs or one or more UL channel state information RSs; and receive, based at least in part on the first configuration message, at least one of one or more UL transmit RSs from one or more UEs or one more DL RSs from one or more APs.

Additionally, the processor 700 may be configured to or operable to support any one or combination of where the first configuration message further includes at least one of a time period, a periodic time-domain behavior configuration, a semi-persistent time-domain behavior configuration, an aperiodic time-domain behavior configuration, a time-frequency resources configuration, an UL transmit RS pattern, one or more UL transmit beam indexes associated with a transmit beam pattern, or one or more DL receive beam indexes associated with a receive beam pattern; the first configuration message at least one of: classifies at least one UL transmit RS of a plurality of UL transmit RSs into at least one group of three groups, wherein an UL transmit RS of a first group of the three groups is designated for UE cell searching for a DL AP, an UL transmit RS of a second group of the three groups is designated for UE cell searching for an UL AP, and an UL transmit RS of a third group of the three groups is designated for an inter-UE CLI RS; associates at least one UL transmit RS of the plurality of UL transmit RSs with one or more of a traffic quality of service or a traffic priority class; or classifies at least one UL transmit RS of the plurality of UL transmit RSs into at least one of a cell common RS, a UE group common RS, or a UE specific RS each associated with one or more of a weight or a priority level; the first configuration message configures UE to report at least one of CLI measured quantity associated with the corresponding uplink transmit RS resource index, UL transmit beam index, downlink receive beam index, measurement subband index, or measurement resource index, wherein the CLI measured quantity comprises at least one of a CLI RSRP or CLI RSSI.

Additionally, the processor 700 may be configured to or operable to support any one or combination of where the first configuration message configures the processor to at least one of: report an inter-UE CLI measured quantity based at least in part on the inter-UE CLI measured quantity being below or above a configured threshold; report one or more of a maximum or minimum inter-UE CLI measured quantity of a plurality of inter-UE CLI measured quantities; or report at least one inter-UE CLI measured quantity of a plurality of inter-UE CLI measured quantities by integrating the at least one inter-UE CLI measured quantity into one or more channel state information reported quantities; the first configuration message further includes a configuration for at least one of self-interference measurement and reporting resources or channel state information measurement and reporting resources each associated with at least one of a time period, a periodic, semi-persistent, or aperiodic time-domain behavior configuration, a time-frequency resources configuration, an UL transmit RS pattern, UL transmit RS beam indexes associated with a transmit beam pattern, or DL receive beam indexes associated with a receive beam pattern.

Additionally, the processor 700 may be configured to or operable to support any one or combination of where the first configuration message configures the processor to at least one of: report at least one of self-interference measured quantity associated with a corresponding UL transmit RS resource index, UL transmit beam index, DL receive beam index, measurement subband index, or measurement resource index, wherein the self-interference measured quantity includes at least one of a self-interference RS received power or a self-interference received signal strength indicator; report at least one self-interference measured quantity being below or above a configured threshold; report a maximum or minimum self-interference measured quantity of a plurality of self-interference measured quantities; report at least one self-interference measured quantity of a plurality of self-interference measured quantities by integrating the at least one self-interference measured quantity into one or more channel state information reported quantities; or report at least one of a channel state information measured quantity associated with a corresponding DL RS index, a measurement resource index, a measurement subband index, or an AP index; the at least one controller is configured to cause the processor to receive a second configuration message indicating at least one of a DL signal or channel configuration resources associated with at least one of a channel state information, a quasi-co-location or transmission configuration indicator state configuration, an UL signal or channel configuration resources associated with a channel state information, or quasi co-location or transmission configuration indicator state configuration; the second configuration message further includes at least one of assigned APs indexes and locations in DL mode, assigned APs indexes and locations in UL mode, or assigned APs indexes and locations in FD mode, associated with an assignment period.

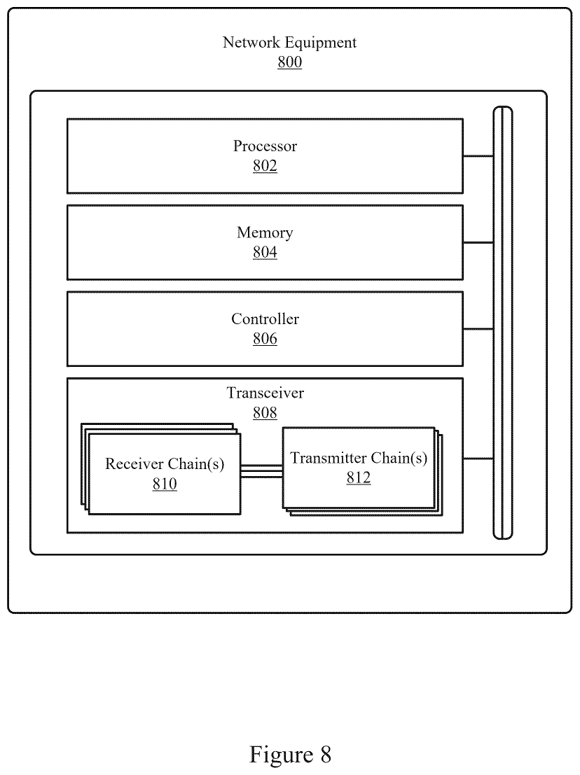

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting a first configuration message including one or more UL transmit RS resources, one or more inter-UE CLI measurement resources, and one or more inter-UE CLI reporting resources; receiving one or more RSs including at least one of one or more UE UL RSs, one or more inter-AP CLI RSs, or one or more DL RSs; and transmitting one or more RSs including at least one of one or more DL channel state information references signals or one or more inter-AP CLI RSs.

Additionally, the NE 800 may be configured to or operable to support any one or combination of receiving a third configuration message including a slot configuration pattern configuring NE to operate in a DL mode, an UL mode, or a FD mode associated with at least one of a time period, one or more frequency resources, one or more time resources, a periodic time-domain behavior configuration, a semi-persistent time-domain behavior configuration, or a aperiodic time-domain behavior configuration; the third configuration message at least one of: configures the NE with at least one of a plurality of DL transmit RS resources or a plurality of inter-AP CLI measurement and reporting resources each associated with at least one of a time period, a periodic time-domain behavior configuration, a semi-persistent time-domain behavior configuration, or an aperiodic time-domain behavior configuration, a time-frequency resources configuration, a DL transmit RS pattern, one or more DL transmit beam indexes associated with a transmit beam pattern, or one or more UL beam indexes associated with a receive beam pattern; configures the NE to report at least one of a inter-AP CLI measured quantity associated with a corresponding DL transmit RS resource index, an UL receive beam index, a DL transmit beam index, a measurement subband index, or a measurement resource index, wherein the inter-AP CLI measured quantity includes one or more of a CLI RS received power or a CLI received signal strength indicator; configures the NE to report an inter-AP CLI measured quantity if that is below or above a configured threshold; configures the NE to report a maximum or minimum inter-AP CLI measured quantity of a plurality of CLI measured quantities; or configures the NE to report at least one inter-AP CLI measured quantity of a plurality of inter-AP CLI measured quantities by integrating the at least one inter-AP CLI measured quantity into an UL channel state information reported quantity.

Additionally, the NE 800 may be configured to or operable to support any one or combination of receiving a third configuration message including at least one of a plurality of self-interference measurement and reporting resources or a plurality of UL channel state information measurement and reporting resources each associated with at least one of a time period, a periodic time-domain behavior configuration, a semi-persistent time-domain behavior configuration, or an aperiodic time-domain behavior configuration, a time-frequency resources configuration, a DL transmit RS pattern, DL transmit beam indexes associated with a transmit beam pattern, or UL receive beam indexes associated with an receive beam pattern; receiving a third configuration message configuring the NE to at least one of: report at least one self-interference measured quantity that is below or above a configured threshold; report a maximum or minimum self-interference measured quantity of a plurality of self-interference measured quantities; report at least one self-interference measured quantity of a plurality of self-interference measured quantities by integrating the at least one self-interference measured quantity into one or more UL channel state information reported quantities; or report at least one UL channel state information measured quantity associated with a corresponding UL transmit RS resource index, a measurement resource index, a measurement subband index, or an AP index; receiving a third configuration message classifying at least one configured DL transmit RS into one group of four groups, wherein a RS of a first group of the four groups is configured for indicating when the NE indicates a DL only mode, a RS of a second group of the four groups indicates an UL only mode, a RS of a third group of the four groups indicates a FD mode, and a RS of a fourth group of the four groups indicates an inter-AP CLI RS.

Additionally, the NE 800 may be configured to or operable to support any one or combination of transmitting a predefined signal sequence to indicate a local communication direction assignment; receiving a response message that one or more of: confirms, rejects, or reverts the local communication direction assignment; or indicates or configures at least one of UL signal resources or DL signal resources according to an indicated DL or UL mode; receiving a third configuration message indicating an event-based measurement and reporting resources configuration associated with at least one of time-frequency resources, DL RS resources, UL RS resources, DL transmit beam indexes resources, UL receive beam indexes resources, inter-AP cross-link measurement resources, self-interference measurement resources, a time period, a periodic, or semi-persistent or aperiodic time-domain behavior configuration; the event-based measurement and reporting configuration indicates whether a difference in a first value of an L1-RS received power associated with an active beam and a second value of an L1-RS received power associated with an indicated beam is larger than a configured threshold, and wherein the method further includes transmitting an indication of whether an event occurred via a configured contention-based RS resource or a contention-free RS resource.

Additionally, or alternatively, the NE 800 may support at least one memory (e.g., the memory 804) and at least one processor (e.g., the processor 802) coupled with the at least one memory and configured to cause the NE to transmit a first configuration message including one or more UL transmit RS resources, one or more inter-UE CLI measurement resources, and one or more inter-UE CLI reporting resources; receive one or more RSs including at least one of one or more UE UL RSs, one or more inter-AP CLI RSs, or one or more DL RSs; and transmit one or more RSs including at least one of one or more DL channel state information references signals or one or more inter-AP CLI RSs.

Additionally, the NE 800 may be configured to support any one or combination of where the at least one processor is configured to cause the NE to receive a third configuration message including a slot configuration pattern configuring NE to operate in a DL mode, an UL mode, or a FD mode associated with at least one of a time period, one or more frequency resources, one or more time resources, a periodic time-domain behavior configuration, a semi-persistent time-domain behavior configuration, or a aperiodic time-domain behavior configuration; the third configuration message at least one of: configures the NE with at least one of a plurality of DL transmit RS resources or a plurality of inter-AP CLI measurement and reporting resources each associated with at least one of a time period, a periodic time-domain behavior configuration, a semi-persistent time-domain behavior configuration, or an aperiodic time-domain behavior configuration, a time-frequency resources configuration, a DL transmit RS pattern, one or more DL transmit beam indexes associated with a transmit beam pattern, or one or more UL beam indexes associated with a receive beam pattern; configures the NE to report at least one of a inter-AP CLI measured quantity associated with a corresponding DL transmit RS resource index, an UL receive beam index, a DL transmit beam index, a measurement subband index, or a measurement resource index, wherein the inter-AP CLI measured quantity includes one or more of a CLI RS received power or a CLI received signal strength indicator; configures the NE to report an inter-AP CLI measured quantity if that is below or above a configured threshold; configures the NE to report a maximum or minimum inter-AP CLI measured quantity of a plurality of CLI measured quantities; or configures the NE to report at least one inter-AP CLI measured quantity of a plurality of inter-AP CLI measured quantities by integrating the at least one inter-AP CLI measured quantity into an UL channel state information reported quantity.

Additionally, the NE 800 may be configured to support any one or combination of where the at least one processor is configured to cause the NE to receive a third configuration message including at least one of a plurality of self-interference measurement and reporting resources or a plurality of UL channel state information measurement and reporting resources each associated with at least one of a time period, a periodic time-domain behavior configuration, a semi-persistent time-domain behavior configuration, or an aperiodic time-domain behavior configuration, a time-frequency resources configuration, a DL transmit RS pattern, DL transmit beam indexes associated with a transmit beam pattern, or UL receive beam indexes associated with an receive beam pattern; the at least one processor is configured to cause the NE to receive a third configuration message configuring the NE to at least one of: report at least one self-interference measured quantity that is below or above a configured threshold; report a maximum or minimum self-interference measured quantity of a plurality of self-interference measured quantities; report at least one self-interference measured quantity of a plurality of self-interference measured quantities by integrating the at least one self-interference measured quantity into one or more UL channel state information reported quantities; or report at least one UL channel state information measured quantity associated with a corresponding UL transmit RS resource index, a measurement resource index, a measurement subband index, or an AP index.

Additionally, the NE 800 may be configured to support any one or combination of where the at least one processor is configured to cause the NE to receive a third configuration message classifying at least one configured DL transmit RS into one group of four groups, wherein a RS of a first group of the four groups is configured for indicating when the NE indicates a DL only mode, a RS of a second group of the four groups indicates an UL only mode, a RS of a third group of the four groups indicates a FD mode, and a RS of a fourth group of the four groups indicates an inter-AP CLI RS; the at least one processor is configured to cause the NE to transmit a predefined signal sequence to indicate a local communication direction assignment; the at least one processor is configured to cause the NE to receive a response message that one or more of: confirms, rejects, or reverts the local communication direction assignment; or indicates or configures at least one of UL signal resources or DL signal resources according to an indicated DL or UL mode; the at least one processor is configured to cause the NE to receive a third configuration message indicating an event-based measurement and reporting resources configuration associated with at least one of time-frequency resources, DL RS resources, UL RS resources, DL transmit beam indexes resources, UL receive beam indexes resources, inter-AP cross-link measurement resources, self-interference measurement resources, a time period, a periodic, or semi-persistent or aperiodic time-domain behavior configuration; the event-based measurement and reporting configuration indicates whether a difference in a first value of an L1-RS received power associated with an active beam and a second value of an L1-RS received power associated with an indicated beam is larger than a configured threshold, and wherein the at least one processor is configured to cause the NE to transmit an indication of whether an event occurred via a configured contention-based RS resource or a contention-free RS resource.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

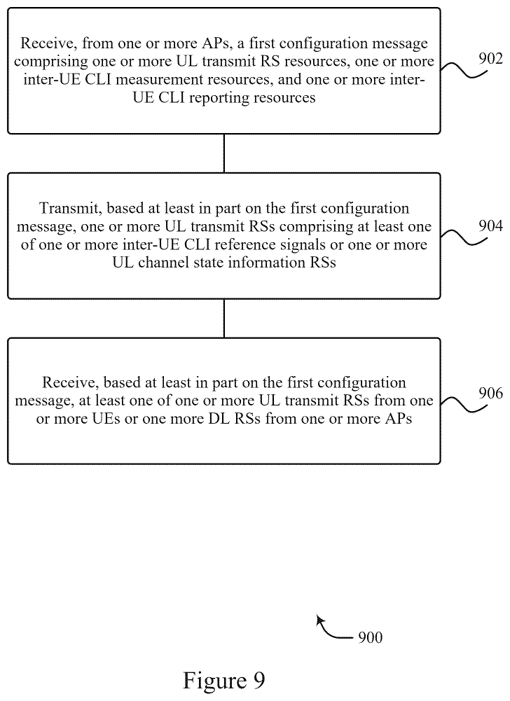

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include receiving, from one or more APs, a first configuration message comprising one or more UL transmit RS resources, one or more inter-UE CLI measurement resources, and one or more inter-UE CLI reporting resources. The operations of 902 may be performed in accordance with examples as described herein. In some implementations, aspects of the operations of 902 may be performed by a UE as described with reference to FIG. 6.

At 904, the method may include transmitting, based at least in part on the first configuration message, one or more UL transmit RSs comprising at least one of one or more inter-UE CLI RSs or one or more UL channel state information RSs. The operations of 904 may be performed in accordance with examples as described herein. In some implementations, aspects of the operations of 904 may be performed by a UE as described with reference to FIG. 6.

At 906, the method may include receiving, based at least in part on the first configuration message, at least one of one or more UL transmit RSs from one or more UEs or one more DL RSs from one or more APs. The operations of 906 may be performed in accordance with examples as described herein. In some implementations, aspects of the operations of 906 may be performed a UE as described with reference to FIG. 6.

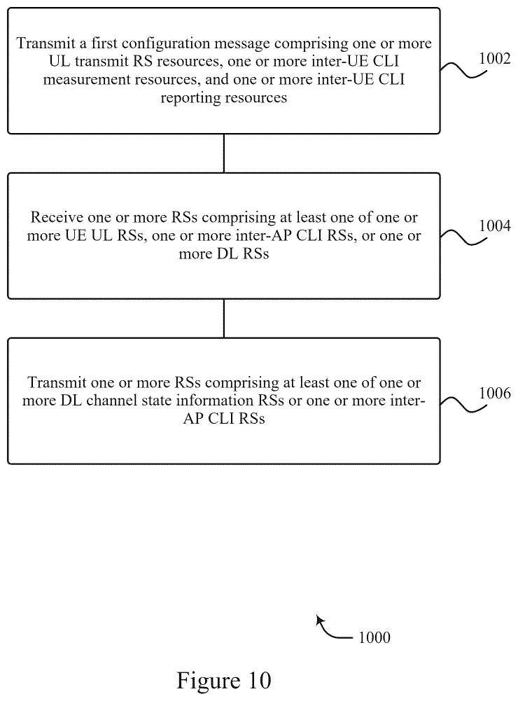

FIG. 10 illustrates a flowchart of a method 1000 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include transmitting a first configuration message comprising one or more UL transmit RS resources, one or more inter-UE CLI measurement resources, and one or more inter-UE CLI reporting resources. The operations of 1002 may be performed in accordance with examples as described herein. In some implementations, aspects of the operations of 1002 may be performed by a NE as described with reference to FIG. 8.

At 1004, the method may include receiving one or more RSs comprising at least one of one or more UE UL RSs, one or more inter-AP CLI RSs, or one or more DL RSs. The operations of 1004 may be performed in accordance with examples as described herein. In some implementations, aspects of the operations of 1004 may be performed by a NE as described with reference to FIG. 8.

At 1006, the method may include transmitting one or more RSs comprising at least one of one or more DL channel state information RSs or one or more inter-AP CLI RSs. The operations of 1006 may be performed in accordance with examples as described herein. In some implementations, aspects of the operations of 1006 may be performed a NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from one or more access points, a first configuration message comprising one or more uplink transmit reference signal resources, one or more inter-UE cross-link interference measurement resources, and one or more inter-UE cross-link interference reporting resources;
transmit, based at least in part on the first configuration message, one or more uplink transmit reference signals comprising at least one of one or more inter-UE cross-link interference reference signals or one or more uplink channel state information reference signals; and
receive, based at least in part on the first configuration message, at least one of one or more uplink transmit reference signals from one or more UEs or one more downlink reference signals from one or more access points.

2. The UE of claim 1, wherein the first configuration message further comprises at least one of a time period, a periodic time-domain behavior configuration, a semi-persistent time-domain behavior configuration, an aperiodic time-domain behavior configuration, a time-frequency resources configuration, an uplink transmit reference signal pattern, one or more uplink transmit beam indexes associated with a transmit beam pattern, or one or more downlink receive beam indexes associated with a receive beam pattern.

3. The UE of claim 1, wherein the first configuration message at least one of:
classifies at least one uplink transmit reference signal of a plurality of uplink transmit reference signals into at least one group of three groups, wherein an uplink transmit reference signal of a first group of the three groups is designated for UE cell searching for a downlink access point, an uplink transmit reference signal of a second group of the three groups is designated for UE cell searching for an uplink access point, and an uplink transmit reference signal of a third group of the three groups is designated for an inter-UE cross-link interference reference signal;
associates at least one uplink transmit reference signal of the plurality of uplink transmit reference signals with one or more of a traffic quality of service or a traffic priority class; or
classifies at least one uplink transmit reference signal of the plurality of uplink transmit reference signals into at least one of a cell common reference signal, a UE group common reference signal, or a UE specific reference signal each associated with one or more of a weight or a priority level.

4. The UE of claim 1, wherein the first configuration message configures the UE to at least one of:
report an inter-UE cross-link interference measured quantity based at least in part on the inter-UE cross-link interference measured quantity being below or above a configured threshold;
report one or more of a maximum or minimum inter-UE cross-link interference measured quantity of a plurality of inter-UE cross-link interference measured quantities; or
report at least one inter-UE cross-link interference measured quantity of a plurality of inter-UE cross-link interference measured quantities by integrating the at least one inter-UE cross-link interference measured quantity into one or more channel state information reported quantities.

5. The UE of claim 1, wherein the first configuration message further comprises a configuration for at least one of self-interference measurement and reporting resources or channel state information measurement and reporting resources each associated with at least one of a time period, a periodic, semi-persistent, or aperiodic time-domain behavior configuration, a time-frequency resources configuration, an uplink transmit reference signal pattern, uplink transmit reference signal beam indexes associated with a transmit beam pattern, or downlink receive beam indexes associated with a receive beam pattern.

6. The UE of claim 5, wherein the first configuration message configures the UE to at least one of:
report at least one of self-interference measured quantity associated with a corresponding uplink transmit reference signal resource index, uplink transmit beam index, downlink receive beam index, measurement subband index, or measurement resource index, wherein the self-interference measured quantity comprises at least one of a self-interference reference signal received power or a self-interference received signal strength indicator;
report at least one self-interference measured quantity being below or above a configured threshold;
report a maximum or minimum self-interference measured quantity of a plurality of self-interference measured quantities;
report at least one self-interference measured quantity of a plurality of self-interference measured quantities by integrating the at least one self-interference measured quantity into one or more channel state information reported quantities; or
report at least one of a channel state information measured quantity associated with a corresponding downlink reference signal index, a measurement resource index, a measurement subband index, or an access point index.

7. The UE of claim 1, wherein the at least one processor is configured to cause the UE to receive a second configuration message indicating at least one of a downlink signal or channel configuration resources associated with at least one of a channel state information, a quasi-co-location or transmission configuration indicator state configuration, an uplink signal or channel configuration resources associated with a channel state information, or quasi co-location or transmission configuration indicator state configuration.

8. The UE of claim 7, wherein the second configuration message further comprises at least one of assigned access points indexes and locations in downlink mode, assigned access points indexes and locations in uplink mode, or assigned access points indexes and locations in full-duplex mode, associated with an assignment period.

9. A network equipment for wireless communication, comprising:
at least one memory; and
at least one processor coupled with the at least one memory and configured to cause the network equipment to:
transmit a first configuration message comprising one or more uplink transmit reference signal resources, one or more inter-user equipment (UE) cross-link interference measurement resources, and one or more inter-UE cross-link interference reporting resources;
receive one or more reference signals comprising at least one of one or more UE uplink reference signals, one or more inter-access point cross-link interference reference signals, or one or more downlink reference signals; and
transmit one or more reference signals comprising at least one of one or more downlink channel state information references signals or one or more inter-access point cross-link interference reference signals.

10. The network equipment of claim 9, wherein the at least one processor is configured to cause the network equipment to receive a third configuration message comprising a slot configuration pattern configuring network equipment to operate in a downlink mode, an uplink mode, or a full-duplex mode associated with at least one of a time period, one or more frequency resources, one or more time resources, a periodic time-domain behavior configuration, a semi-persistent time-domain behavior configuration, or a aperiodic time-domain behavior configuration.

11. The network equipment of claim 10, wherein the third configuration message at least one of:
configures the network equipment with at least one of a plurality of downlink transmit reference signal resources or a plurality of inter-access point cross-link interference measurement and reporting resources each associated with at least one of a time period, a periodic time-domain behavior configuration, a semi-persistent time-domain behavior configuration, or an aperiodic time-domain behavior configuration, a time-frequency resources configuration, a downlink transmit reference signal pattern, one or more downlink transmit beam indexes associated with a transmit beam pattern, or one or more uplink beam indexes associated with a receive beam pattern;
configures the network equipment to report at least one of a inter-access point cross-link interference measured quantity associated with a corresponding downlink transmit reference signal resource index, an uplink receive beam index, a downlink transmit beam index, a measurement subband index, or a measurement resource index, wherein the inter-access point cross-link interference measured quantity comprises one or more of a cross-link interference reference signal received power or a cross-link interference received signal strength indicator;
configures the network equipment to report an inter-access point cross-link interference measured quantity if that is below or above a configured threshold;
configures the network equipment to report a maximum or minimum inter-access point cross-link interference measured quantity of a plurality of cross-link interference measured quantities; or
configures the network equipment to report at least one inter-access point cross-link interference measured quantity of a plurality of inter-access point CLI measured quantities by integrating the at least one inter-access point cross-link interference measured quantity into an uplink channel state information reported quantity.

12. The network equipment of claim 9, wherein the at least one processor is configured to cause the network equipment to receive a third configuration message comprising at least one of a plurality of self-interference measurement and reporting resources or a plurality of uplink channel state information measurement and reporting resources each associated with at least one of a time period, a periodic time-domain behavior configuration, a semi-persistent time-domain behavior configuration, or an aperiodic time-domain behavior configuration, a time-frequency resources configuration, a downlink transmit reference signal pattern, downlink transmit beam indexes associated with a transmit beam pattern, or uplink receive beam indexes associated with an receive beam pattern.

13. The network equipment of claim 9, wherein the at least one processor is configured to cause the network equipment to receive a third configuration message configuring the network equipment to at least one of:
report at least one self-interference measured quantity that is below or above a configured threshold;
report a maximum or minimum self-interference measured quantity of a plurality of self-interference measured quantities;
report at least one self-interference measured quantity of a plurality of self-interference measured quantities by integrating the at least one self-interference measured quantity into one or more uplink channel state information reported quantities; or
report at least one uplink channel state information measured quantity associated with a corresponding uplink transmit reference signal resource index, a measurement resource index, a measurement subband index, or an access point index.

14. The network equipment of claim 9, wherein the at least one processor is configured to cause the network equipment to receive a third configuration message classifying at least one configured downlink transmit reference signal into one group of four groups, wherein a reference signal of a first group of the four groups is configured for indicating when the network equipment indicates a downlink only mode, a reference signal of a second group of the four groups indicates an uplink only mode, a reference signal of a third group of the four groups indicates a full-duplex mode, and a reference signal of a fourth group of the four groups indicates an inter-access point cross-link interference reference signal.

15. The network equipment of claim 9, wherein the at least one processor is configured to cause the network equipment to transmit a predefined signal sequence to indicate a local communication direction assignment.

16. The network equipment of claim 15, wherein the at least one processor is configured to cause the network equipment to receive a response message that one or more of:
confirms, rejects, or reverts the local communication direction assignment; or
indicates or configures at least one of uplink signal resources or downlink signal resources according to an indicated downlink or uplink mode.

17. The network equipment of claim 9, wherein the at least one processor is configured to cause the network equipment to receive a third configuration message indicating an event-based measurement and reporting resources configuration associated with at least one of time-frequency resources, downlink reference signal resources, uplink reference signal resources, downlink transmit beam indexes resources, uplink receive beam indexes resources, inter-access point cross-link measurement resources, self-interference measurement resources, a time period, a periodic, or semi-persistent or aperiodic time-domain behavior configuration.

18. The network equipment of claim 17, wherein the event-based measurement and reporting configuration indicates whether a difference in a first value of an L1-reference signal received power associated with an active beam and a second value of an L1-reference signal received power associated with an indicated beam is larger than a configured threshold, and wherein the at least one processor is configured to cause the network equipment to transmit an indication of whether an event occurred via a configured contention-based reference signal resource or a contention-free reference signal resource.

19. A processor for wireless communication, comprising:
at least one controller coupled with at least one memory and configured to cause the processor to:
receive, from one or more access points, a first configuration message comprising one or more uplink transmit reference signal resources, one or more inter-user equipment (UE) cross-link interference measurement resources, and one or more inter-UE cross-link interference reporting resources;
transmit, based at least in part on the first configuration message, one or more uplink transmit reference signals comprising at least one of one or more inter-UE cross-link interference reference signals or one or more uplink channel state information reference signals; and
receive, based at least in part on the first configuration message, at least one of one or more uplink transmit reference signals from one or more UEs or one more downlink reference signals from one or more access points.

20. A method performed by a user equipment (UE), the method comprising:
receiving, from one or more access points, a first configuration message comprising one or more uplink transmit reference signal resources, one or more inter-UE cross-link interference measurement resources, and one or more inter-UE cross-link interference reporting resources;
transmitting, based at least in part on the first configuration message, one or more uplink transmit reference signals comprising at least one of one or more inter-UE cross-link interference reference signals or one or more uplink channel state information reference signals; and
receiving, based at least in part on the first configuration message, at least one of one or more uplink transmit reference signals from one or more UEs or one more downlink reference signals from one or more access points.
